(19) United States
(12) Patent Application Publication
(10) Pub. No.: US 2010/0275235 A1
(43) Pub. Date: Oct. 28, 2010

(54) SENSORY EFFECT MEDIA GENERATING AND CONSUMING METHOD AND APPARATUS THEREOF

(76) Inventors: Sanghyun Joo, Daejon (KR); Bum-Suk Choi, Daejon (KR); Hae-Ryong Lee, Daejon (KR); Kwang-Roh Park, Daejon (KR); Chae-Kyu Kim, Daejon (KR); Munchurl Kim, Daejon (KR); Jaegon Kim, Gyeonggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/738,288

(22) PCT Filed: Oct. 16, 2008
(86) PCT No.: PCT/KR08/06126

§ 371 Date: Jul. 12, 2010

Related U.S. Application Data
(60) Provisional application No. 60/980,182, filed on Oct. 16, 2007.

(51) Int. Cl. H04N 7/18

(52) U.S. Cl. 725/74

(57) ABSTRACT

Provided is a method and apparatus for generating and consuming sensory effect media. The method for generating sensory effect media includes receiving sensory effect information about sensory effects that are applied to media, and generating sensory effect metadata including the received sensory effect information.

### TECHNICAL FIELD

The present invention relates to a method and apparatus for generating and consuming media; and, more particularly, to a method and apparatus for generating and consuming sensory effect media.

This work was supported by the IT R&D program of MIC/IITA [2007-S-010-01, “Development of Ubiquitous Home Media Service System based on SMMD”].

### BACKGROUND ART

In general, media includes audio and video. The audio may be voice or sound, and the video may be motion pictures or images. When a user consumes or reproduces the media, the user can obtain information about the media by using metadata. The metadata is data about the media. Meanwhile, a device for reproducing media has also made an advance from an analog type device for reproducing analog media to a digital type device for reproducing digital media.

Generally, an audio output device such as a speaker and a video output device such as a display device are used for reproducing the media.

FIG. 1 illustrates a conventional media technology. Referring to FIG. 1, media 102 is outputted to a user using a media consuming method 104. The media consuming method 104 according to the related art only includes devices for outputting audio and video.

Many researches have been made to develop a technology for effectively providing media to users. For example, audio signals evolve into multi-channel signals or multi-object signals, and video technology has also advanced to high definition display, a stereoscopic image, or a 3-D image display technology.

Related to such a media technology, a media concept and a multimedia processing technology have also advanced. For example, Moving Picture Experts Group (MPEG) technology was introduced from MPEG-1 to MPEG-21 as well as MPEG-2, MPEG-4, and MPEG-7. MPEG-1 defines a format for storing audio and video, and MPEG-2 defines specifications for transmitting media, while MPEG-4 defines an object based media structure. MPEG-7 defines specifications for metadata of media, and MPEG-21 defines a framework for distributing media.

As described above, the media according to the related art is limited to audio and video. That is, it is impossible to maximize the effect of reproducing the media by interacting with various devices.

### DISCLOSURE

### Technical Problem

An embodiment of the present invention is directed to a method and apparatus for generating and consuming sensory effect media to maximize the effect of reproducing media.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for generating sensory effect media, including receiving sensory effect information about sensory effects that are applied to media, and generating sensory effect metadata including the received sensory effect information.

In accordance with another aspect of the present invention, there is provided an apparatus for generating sensory effect media, including an input unit for receiving sensory effect information about sensory effects that are applied to media, and a sensory effect metadata generator for generating sensory effect metadata including the received sensory effect information.

In accordance with another aspect of the present invention, there is provided a method for consuming sensory effect media, including receiving sensory effect metadata including sensory effect information about sensory effects that are applied to media, and searching for devices that realizes the sensory effects and controlling the devices according to the sensory effect information.

In accordance with another aspect of the present invention, there is provided an apparatus for consuming sensory effect media, including an input unit for receiving sensory effect metadata having sensory effect information about sensory effects that are applied to media, and a controller for searching for devices that realizes the sensory effects and controlling the devices according to the sensory effect information.

### ADVANTAGEOUS EFFECTS

The method and apparatus for generating and consuming sensory effect media according to the present invention maximizes a media reproduction effect.

### BRIEF DESCRIPTION OF THE DRAWINGS

FIG. 1 illustrates a media technology according to a related art.

FIG. 2 is a conceptual diagram describing sensory effect media in accordance with an embodiment of the present invention.

FIG. 3 is a block diagram illustrating an apparatus for generating sensory effect media in accordance with an embodiment of the present invention.

FIG. 4 is a diagram illustrating an apparatus for consuming a sensory effect media in accordance with an embodiment of the present invention.

FIG. 5 is a conceptual diagram describing the reproduction of sensory effects in accordance with an embodiment of the present invention.

FIG. 6 is a block diagram illustrating an apparatus for generating and consuming sensory effect media in accordance with a first embodiment of the present invention.

FIG. 7 is a block diagram illustrating an apparatus for generating and consuming sensory effect media in accordance with a second embodiment of the present invention.

FIG. 8 is a block diagram illustrating an apparatus for generating and consuming sensory effect media in accordance with a third embodiment of the present invention.

FIG. 9 is a block diagram illustrating an apparatus for generating and consuming sensory effect media in accordance with a fourth embodiment of the present invention.

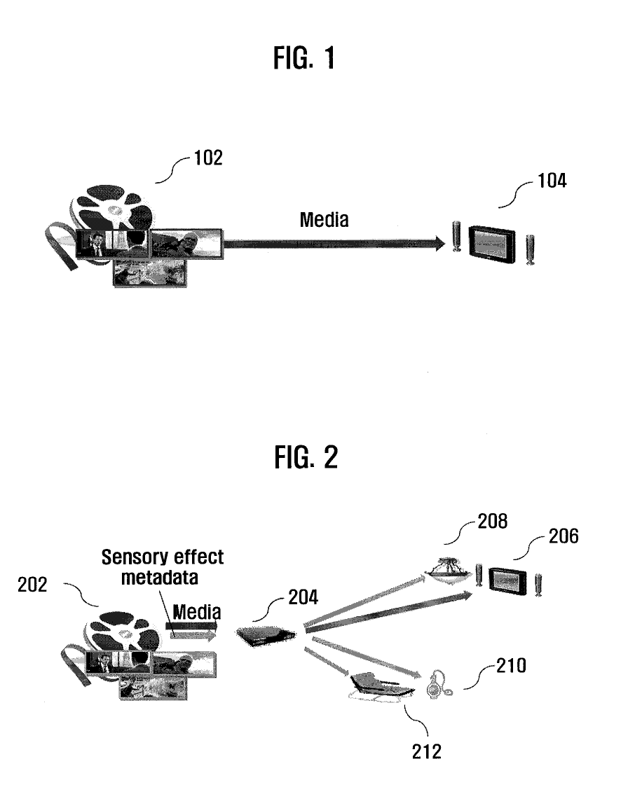

### BEST MODE FOR THE INVENTION

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

Also, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures.

For example, block diagrams of the present invention should be understood to show a conceptual viewpoint of an exemplary circuit that embodies the principles of the present invention. Similarly, all the flowcharts, state conversion diagrams, pseudo codes and the like can be expressed substantially in a computer-readable media, and whether or not a computer or a processor is described distinctively, they should be understood to express various processes operated by a computer or a processor.

Functions of various devices illustrated in the drawings including a functional block expressed as a processor or a similar concept can be provided not only by using hardware dedicated to the functions, but also by using hardware capable of running proper software for the functions. When a function is provided by a processor, the function may be provided by a single dedicated processor, single shared processor, or a plurality of individual processors, part of which can be shared.

The apparent use of a term, ‘processor’, ‘control’or similar concept, should not be understood to exclusively refer to a piece of hardware capable of running software, but should be understood to include a digital signal processor (DSP), hardware, and ROM, RAM and non-volatile memory for storing software, implicatively. Other known and commonly used hardware may be included therein, too.

In the claims of the present specification, an element expressed as a means for performing a function described in the detailed description is intended to include all methods for performing the function including all formats of software, such as combinations of circuits for performing the intended function, firmware/microcode and the like. To perform the intended function, the element is cooperated with a proper circuit for performing the software. The present invention defined by claims includes diverse means for performing particular functions, and the means are connected with each other in a method requested in the claims. Therefore, any means that can provide the function should be understood to be an equivalent to what is figured out from the present specification.

Other objects and aspects of the invention will become apparent from the following description of the embodiments with reference to the accompanying drawings, which is set forth hereinafter. The same reference numeral is given to the same element, although the element appears in different drawings. In addition, if further detailed description on the related prior arts is determined to obscure the point of the present invention, the description is omitted. Hereafter, preferred embodiments of the present invention will be described in detail with reference to the drawings.

A conventional apparatus for generating and consuming (or reproducing) media outputs and displays audio and video only. However, human beings have not only a visual sense and an auditory sense but also an olfactory sense and a tactile sense. Lately, many researches have been made to develop a device that stimulates the five senses of a user, such as the tactile sense and the olfactory sense.

Home appliances used to be controlled generally by analog signals, but the home appliances have advanced to be controlled by digital signals.

Accordingly, a concept of media has also advanced to include not only audio and/or video data but also sensory effect data to control various devices that stimulate the olfactory sense and the tactile sense in order to maximize the effect of reproducing the media.

Recently, a single media single device (SMSD) based service is available. The SMSD based service is a media service that enables a user to reproduce one media through one device. However, many researches have been made to develop a single media multi device (SMMD)-based service for maximizing the effect of reproducing media in Ubiquitous home. The SMMD-based service is a media service that enables a user to reproduce one media through a plurality of devices by interacting with the plurality of devices. Therefore, it is necessary to advance from media to sensory effect media that enables a user not only to watch and/or hear the media but also to sense the sensory effects of the media through the five senses of the user. It is expected that the sensory effect media will expand a media industry and a market of a sensory effect device and provide rich experience to a user by maximizing the effect of reproducing the media. Therefore, the sensory effect media encourage users to consume more media.

FIG. 2 is a conceptual diagram describing sensory effect media in accordance with an embodiment of the present invention. Referring to FIG. 2, media 202 and sensory effect metadata are inputted to a sensory effect media consuming method 204. For example, the media 202 may be provided from a media provider (not shown), and the sensory effect metadata may be provided from a sensory effect provider (not shown).

The media 202 includes audio and video, and the sensory effect metadata 202 includes sensory effect information for reproducing sensory effects. The metadata 202 may include all information that can maximize the effect of reproducing the media 202. For example, the sensory effects for a visual sense, an olfactory sense, and a tactile sense are shown in FIG. 2. Accordingly, the sensory effect information includes visual effect information, olfactory effect information, and tactile effect information.

The sensory effect media consuming method 204 according to the present embodiment controls a media output device 206 to receive and reproduce the media 202. The sensory effect media consuming method 204 controls sensory effect devices 208, 210, and 222 based on the visual effect information, the olfactory effect information, and the tactile effect information. For example, a dimmer 208 is controlled according to the visual effect information, a perfumer 210 is controlled according to the olfactory effect information, and a vibrating device 212 such as a chair is controlled according to the tactile effect information.

When a device reproduces video including a scene of lightning and thunder, the dimmer 208 is turned on and off, or when a device reproduces video having a scene of foods or a green field, the perfumer 210 is controlled. Furthermore, when a device reproduces video having a scene of car chasing, the vibrating device 212 is controlled. Therefore, the corresponding sensory effects can be provided to users with the video.

The sensory effect information, which is included in the sensory effect metadata, may include special effect information for reproducing the sensory effects and control information for controlling devices that perform the sensory effects. The sensory effect metadata further include device information about devices that perform the sensory effects. Various users may be enabled to maximally reproduce sensory effects using sensory effect devices that the user owns by defining information to be included in the sensory effect information. For example, if a user owns the dimmer 208 only, the user may reproduce the sensory effects by controlling only the dimmer 210. If a user owns the dimmer 208 and the perfumer 210, the user may reproduce the sensory effects more realistically by controlling not only the dimmer 208 but also the perfumer 210.

Meanwhile, it is necessary to synchronize such sensory effects with audio or video of the media.

Therefore, the control information may include synchronization information for synchronizing the media with the sensory effect.

Hereinafter, the apparatus and method for generating and consuming sensory effect media according to the present invention will be described in detail.

<Generation of Sensory Effect Media>

Hereinafter, method and apparatus for generating sensory effect media according to an embodiment of the present invention will be described.

The method for generating sensory effect media according to the present embodiment includes receiving sensory effect information on sensory effects applied to media, and generating sensory effect metadata including the received sensory effect information. Accordingly, a user owning various types of sensory effect devices is enabled to reproduce proper sensory effects based on the generated sensory effect metadata. The generated sensory effect metadata may be transferred to a user through various paths.

The method may further include transmitting the sensory effect metadata to a user terminal. If a sensory effect service provider generates the sensory effect metadata, the sensory effect metadata may be directly provided to a user independently from the media. For example, if a user already owns media of a predetermined movie, the user may request sensory effect metadata of the predetermined movie to a sensory effect service provider, receive the requested sensory effect metadata from the sensory effect service provider, and reproduce sensory effects of the predetermined movie using the sensory effect metadata.

The method may further include generating sensory effect media by packaging the generated sensory effect metadata and the media, and transmitting the sensory effect media to the user terminal. The sensory effect service provider may provide the media and the sensory effect metadata at the same time. The sensory effect service provider generates a sensory effect metadata, generates sensory effect media by combining or packaging the generated sensory effect metadata with the media, and transmits the generated sensory effect media to a user terminal. The sensory effect media may be formed in a file of a sensory effect media format to reproduce sensory effects. The sensory effect media format may be a standard file format for sensory effect reproduction.

The sensory effect information may include special effect information for reproducing sensory effects and control information for controlling devices that perform the sensory effects. The sensory effect information may further include device information on devices that perform sensory effects. The special effect information may differ according to scenes of media. The sensory effect may include susceptibility as well as the five senses of sensory organs. For example, the special effect information may information for moving curtains or vibrating windows for making audiences of a horror movie to fear. The special effect information may include information for turning on or off dimmers for reproducing the special effect of lighting or thunder. The device information is information on devices that perform the sensory effects. Such device information includes predetermined information on a device that reproduces sensory effects according to the special effect information. The control information includes information for controlling devices according to the device information or according to the special effect information. The control information includes synchronization information for synchronizing the media with the sensory effects. The synchronization information makes the sensory effects to be reproduced according to the progression of scenes of media.

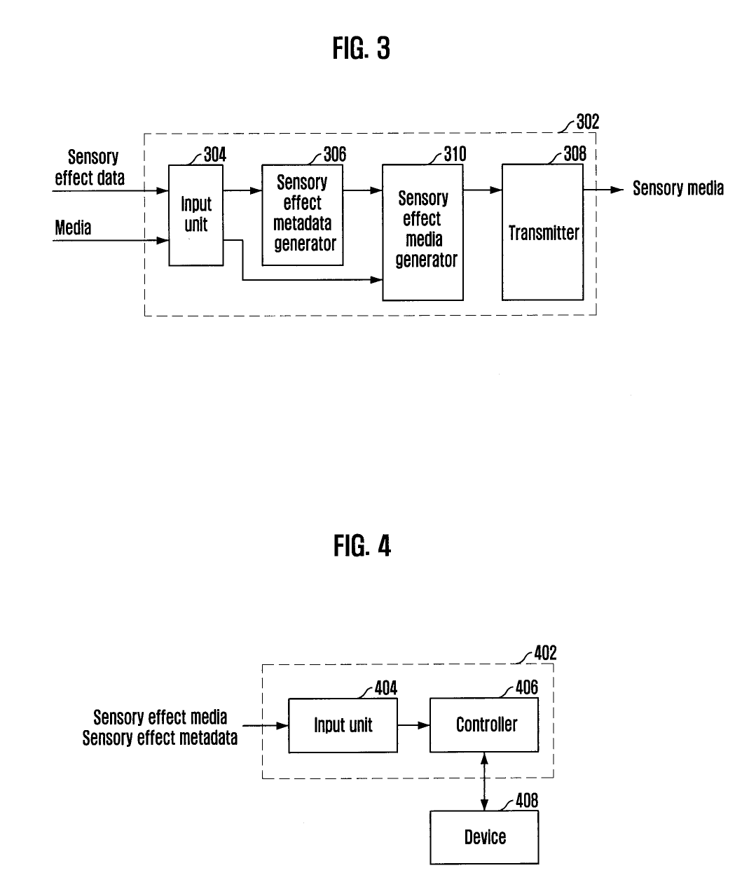

FIG. 3 is a block diagram illustrating an apparatus for generating a sensory effect media in accordance with an embodiment of the present invention. Referring to FIG. 3, the sensory effect media generating apparatus 302 includes an input unit 304 for receiving sensory effect information on sensory effects that are applied to media, and a sensory effect metadata generator 306 for generating sensory effect metadata including the received sensory effect information. The sensory effect media generating apparatus 302 may further include a transmitter 308 for transmitting the sensory effect metadata to a user terminal.

The sensory effect generating apparatus may further include a sensory effect generator for generating sensory effect media by packaging the generated sensory effect metadata and the media. The transmitter may transmit the sensory effect media to the user terminal. In case of generating the sensory effect media, the input unit 304 may receive media and the sensory effect media generator 310 generates the sensory effect media by combining or packaging the received media and the sensory effect metadata generated by the sensory effect metadata generator 306.

The sensory effect information may include special effect information for reproducing sensory effects and control information for controlling devices that perform the sensory effects. The control information may include synchronization information for synchronization of the media and the sensory effects. The sensory effect information may further include device information on devices that perform the sensory effects.

Since other details of the sensory effect generating apparatus are identical to those of the sensory effect media generating method, the description thereof is omitted.

<Consumption of Sensory Effect Media>

Hereinafter, method and apparatus for consuming sensory effect media according to an embodiment of the present invention will be described.

A method for consuming sensory effect media according to the present embodiment includes receiving sensory effect metadata including sensory effect information on sensory effects that are applied to media, and searching for devices for reproducing the sensory effects and controlling the devices according to the sensory effect information. If a user terminal already has media, the sensory effect metadata is received together with media. When the sensory effect metadata is received, the sensory effect metadata is analyzed to determine what kinds of sensory effect information are included therein, and devices owned by a user are searched for to reproduce the sensory effects. Then, the sensory effects are properly reproduced according to the combination of the devices of the user by controlling the searched devices.

While receiving sensory effect metadata, the media may be received too. That is, the sensory effect metadata maybe received together with the media. When the sensory effect metadata and the media are received together, the media may be packaged with the sensory effect metadata. The packaging of the media and the sensory effect metadata may be a file of a sensory effect media format.

The sensory effect information may include special effect information for reproducing sensory effects and control information for controlling devices that perform sensory effects. The control information may include synchronization information for synchronizing the media and the sensory effects. The sensory effect information may further include device information on devices that perform the sensory effects.

Since other details of the sensory effect media consuming method and apparatus are identical to those of the generation of sensory effect media, it is omitted here.

FIG. 4 is a block diagram illustrating an apparatus for consuming a sensory effect media in accordance with an embodiment of the present invention. Referring to FIG. 4, the sensory effect media consuming apparatus 402 includes an input unit 404 for receiving sensory effect metadata having sensory effect information on sensory effects that are applied to media, and a controller 406 for searching for devices 408 that reproduce the sensory effects and controlling the devices according to the sensory effect information. Herein, the sensory effect media consuming apparatus 402 is not limited to a device for reproducing the sensory effect only. The sensory effect media consuming apparatus 402 may be any device that can consume the media, for example, a cellular phone, a mobile terminal such as a personal media player (PMP), TV, and an audio system.

The input unit 404 may further receive the media. In this case, the media is packaged with the metadata.

The sensory effect information may include special effect information for reproducing sensory effects and control information on devices 408 that perform the sensory effects. The control information may include synchronization information for synchronization of the media and the sensory effects. The sensory effect information may further include device information on devices 408 that perform the sensory effects.

Since other details of the sensory effect media consuming apparatus are identical to that of the generation of the sensory effect media, the description thereof is omitted here.

Hereinafter an overall system for reproducing sensory effects according to an embodiment of the present invention will be described.

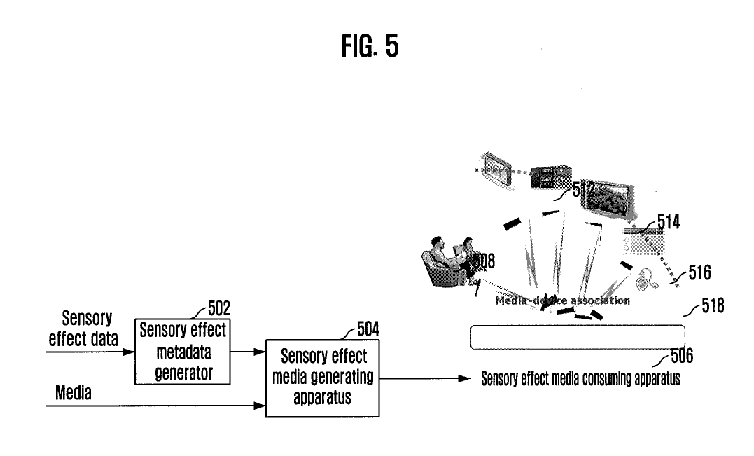

FIG. 5 is a diagram for describing reproducing sensory effects in accordance with an embodiment of the present invention. Referring to FIG. 5, the sensory effect metadata generator 502 receives sensory effect information and generates sensory effect metadata. The media may be transferred to a user independently from the sensory effect metadata. However, it is described that the media is transferred with the sensory effect metadata together to the user in FIG. 5. The sensory effect media generating apparatus 504 generates the sensory effect media using the media and the sensory effect metadata generated by the sensory effect metadata generator 502. The sensory effect media may be formed in a predetermined file format for providing the sensory effect media.

The sensory effect media generated by the sensory effect media generating apparatus 504 is transferred to the sensory effect media consuming apparatus 506. The sensory effect media consuming apparatus 506 searches for sensory effect devices that a user owns. In FIG. 5, a user owns a digital TV 514, a vibration chair 508, a dimmer 510, an audio system 512, an air-conditioner 516, and a perfumer 518. The sensory effect media generating apparatus 504 senses the sensory effect devices of the user, for example, the vibration chair 508, the dimmer 510, the audio system 512, the air-conditioner 516, and the perfumer 518, and controls the searched sensory effect devices to reproduce sensory effects. The sensory effect media generating apparatus 504 also synchronize scenes reproduced at the digital TV 514 with the sensory effect devices.

The sensory effect media consuming apparatus 506 may be connected to the sensory effect devices 508, 510, 512, 514, 516, and 518 through a network in order to control the sensory effect devices. For example, various network technologies such as LonWorks and universal plug and play (UPnP) may be applied to.

Meanwhile, MPEG media technologies such as MPEG-7 and MPEG-21 may be applied together in order to effectively provide media.

Hereinafter, embodiments of the present invention will be described based on subjects of providing and consuming services, such as a sensory effect service provider for providing a sensory effect service, a media service provider for providing media, and a user for reproducing the sensory effects.

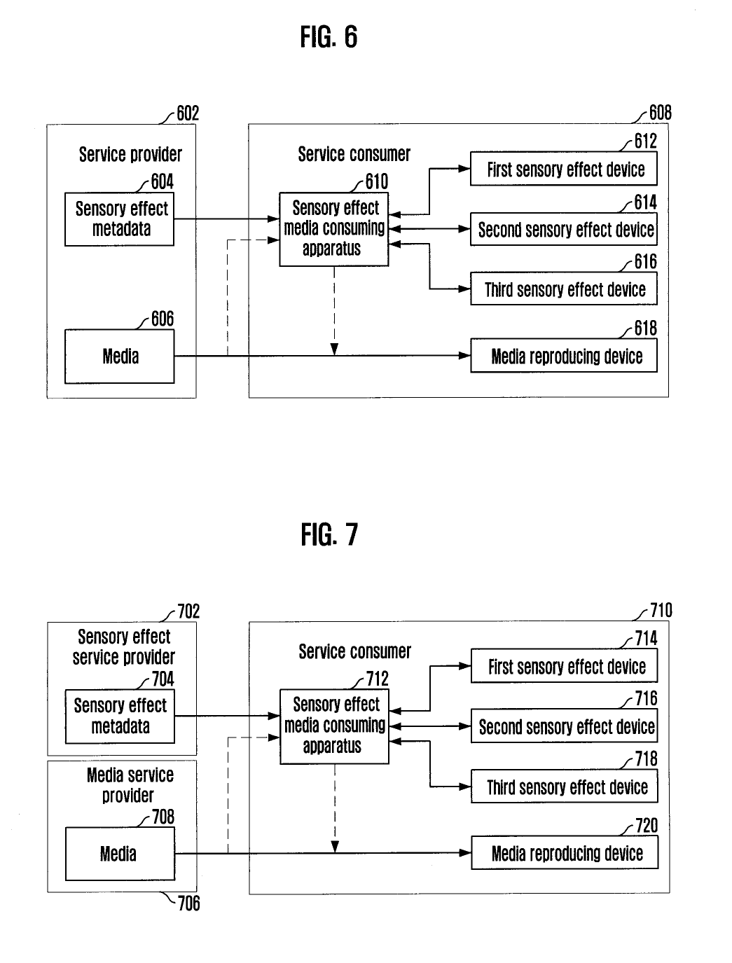

FIGS. 6 to 9 are block diagrams illustrating various embodiments of the present invention.

FIG. 6 is a block diagram illustrating an apparatus for generating and consuming sensory effect media in accordance with a first embodiment of the present invention. Referring to FIG. 6, a service provider 602 transmits sensory effect metadata 604 including sensory effect information and media 606 to a service consumer 608. The service provider 602 provides media and information for reproducing sensory effects of the media to the service consumer 605 at the same time. The service provider 605 may include a broadcasting service provider. The service consumer 608 receives the sensory effect metadata 604 including the sensory effect information and the media 606. The received media 606 is reproduced by a media reproducing device 618, and the received sensory effect metadata 604 is inputted to the sensory effect media consuming apparatus 610. The sensory effect media consuming apparatus 610 is connected to first, second, and third sensory effect devices 612, 614, and 616 through a network and controls the first, second, and third sensory effect devices 612, 614, and 616 according to the received sensory effect metadata 604. The sensory effect media consuming apparatus 610 receives the media 606 for synchronizing reproducing the media 606 with reproducing the sensory effects by the first to third sensory effect devices 612, 614, and 616 and controls the media reproducing device 618 and the sensory effect devices 612, 614, and 616.

FIG. 7 is a block diagram illustrating an apparatus for generating and consuming sensory effect media in accordance with a second embodiment of the present invention. Referring to FIG. 7, a sensory effect provider 702 for providing a sensory effect service is separated from a media service provider 706 for providing media 708. The media service provider is a service provider who provides media 708. The sensory effect service provider 702 is a service provider who provides sensory effect metadata 704 including sensory effect information for reproducing sensory effects in order to provide a sensory effect service for the media 708. The sensory effect service provider 702 transmits the sensory effect metadata 704 to the service consumer 710, and the media service provider 706 transmits the media 708 to the service consumer 710. The transmitted media 708 is reproduced by a media reproducing device 720 of the service consumer 710, and the sensory effect media consuming device 712 controls the sensory effect devices 714, 716, and 718 using the sensory effect metadata. Also, the sensory effect media consuming device 712 synchronizes the media 708 with the sensory effect devices 714, 716, and 718.

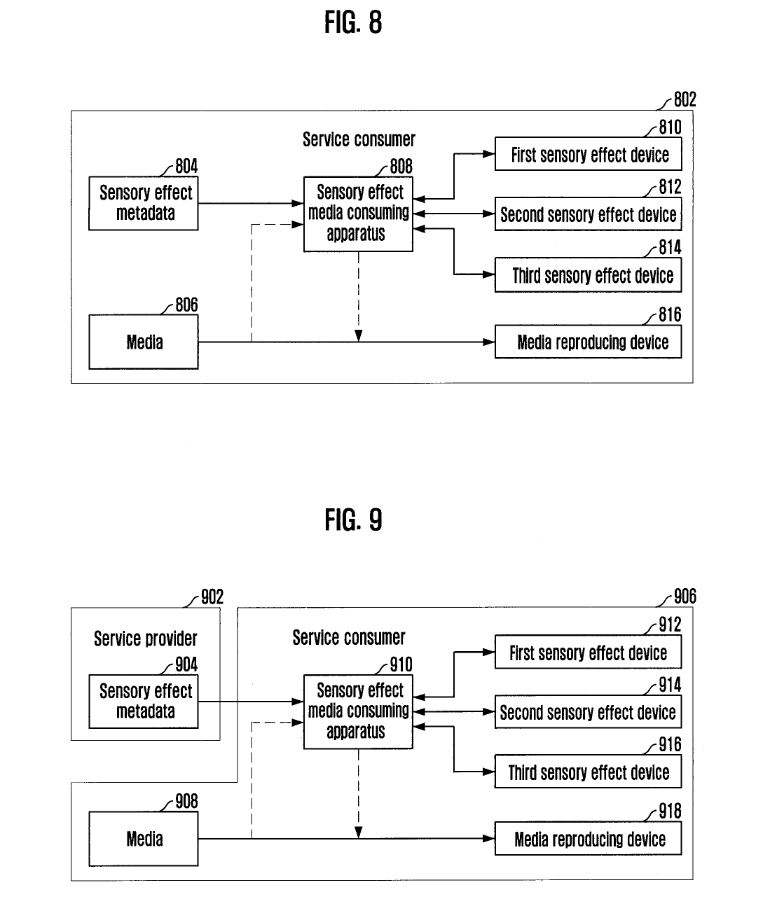

FIG. 8 is a block diagram illustrating an apparatus for generating and consuming sensory effect media in accordance with a third embodiment of the present invention. In FIG. 8, a service consumer side owns information for reproducing not only media but also sensory effects. Here, the service consumer side may include devices of a consumer, such as a DVD player. If the service consumer side is the DVD player, a disk stores information for reproducing the media and the sensory effects. The information for reproducing sensory effects may be stored in a form of metadata. The sensory effect metadata 804 is transmitted to the sensory effect media consuming apparatus 808 and controls the first to third sensory effect devices 810, 812, and 814. The sensory effect media consuming apparatus 808 may include a DVD player. The media 806 is reproduced by the media reproducing device 816 and outputted through a TV. For example, the DVD player may perform a function of the media reproducing device 816 together. The sensory effect media consuming apparatus 808 synchronizes the media 806 and the first to third sensory effect devices 810, 812, and 814.

FIG. 9 is a block diagram illustrating an apparatus for generating and consuming sensory effect media in accordance with a fourth embodiment of the present invention. In FIG. 9, a service provider 902, equivalent to a sensory effect service provider in the third embodiment, provides information for reproducing sensory effects, and a service consumer 906 owns media 908 in the fourth embodiment. The service consumer 906 wants to reproduce sensory effects while reproducing the media 908. In order to reproduce the sensory effects, the service consumer 906 requests information for reproducing the sensory effects to the service provider 902. The service provider 902 transmits information for reproducing sensory effects to the service consumer 906.

The information for reproducing sensory effects may be transmitted to the service consumer 906 in a form of sensory effect metadata. The service consumer 906 reproduces the media 908 using a media reproducing device 918, and the sensory effect media consuming apparatus 910 controls first to third sensory effect devices 912, 914, and 916 using the sensory effect metadata 904. The sensory effect media consuming apparatus 910 synchronizes the media 908 with the first to third sensory effect devices 912, 914, and 916.

Hereinafter, the realization scenarios of the present invention will be described.

1. Mobile Phone

A mobile phone includes a vibrating unit and a Light Emitting Diode (LED) flash light. The mobile phone includes a sensory effect media consuming apparatus. A user selects and reproduces sensory effect media. The sensory effect media may be downloaded into a mobile phone or transmitted in a form of stream. Herein, the sensory effect media includes media and sensory effect metadata having sensory effect information for reproducing sensory effects of the media. The media and the sensory effect metadata may be individually transmitted to the mobile phone. Or, the media may be already stored in the mobile phone, and the sensory effect metadata may be only transmitted to the mobile phone. It is identically applied to other realization scenarios.

The mobile phone activates the vibrating unit and the LED flash. The mobile phone vibrates a body of the mobile phone using the vibrating unit and flashes the LED flash light at a time of reproducing an explosion scene of the media.

2. Digital Cinema

A room includes various devices for reproducing sensory effects. When a user watches a disaster movie, curtains are controlled to wave and dimmers are controlled to make a terror atmosphere. In a scene of lighting, a flash light is turned on and off. In a scene of a rainstorm, a fan is turned on for blowing wind, and a water spray device is turned on. Also, a vibrating chair is turned on in a scene of a ship rolling heavily in the rainstorm.

3. Digital Home

In the morning, sensory effect media may be reproduced to wake a user up. For example, predetermined music is reproduced, and a window curtain opens. If a user does not wake up after few minutes, a bed may be vibrated for waking the user up. The vibration of the bed may be synchronized with the predetermined music.

In the evening, another sensory effect media may be reproduced to help a user to fall in sleep. For example, slow music such as lullaby is reproduced through speakers. All of windows and curtains may be closed, and a dimmer may be turned on. At a predetermined time, the music and the dimmer may be turned off.

The sensory effect media can be applied to a baby walker. The baby walker may include the sensory effect media consuming (reproducing) apparatus, speakers, dimmers, and vibrating unit. While reproducing a predetermined video (audio included) for baby, toys, dimmers, and vibrating units may be controlled according to the sensory effect information. The operation of the toy, the dimmer, and the vibrating unit may be synchronized with the predetermined video.

In addition, a sensory effect media consuming apparatus may reproduce sensory effect media for producing a party atmosphere with a party music at a party and control a vibrating chair and a perfumer with music for a recess time. Also, the sensory effect media may be reproduced in a portable game device. Furthermore, the sensory effect media may be used for producing a pleasant atmosphere in a restaurant or for making students to effectively study in a class room. The sensory effect media may be also used for a media broadcasting service or a video on demand (VOD) service.

Meanwhile, session migration may be applied to the sensory effect media. For example, the session migration may enable a user to continuously reproduce sensory effect media using a mobile terminal although the user leaves home while reproducing sensory effect media using a sensory effect media consuming apparatus. The user may perform the session migration to migrate sessions of the sensory effect media from the sensory effect media consuming apparatus to the mobile terminal. After the session migration, the sensory effect media consuming apparatus stops reproducing the sensory effect media in home, and the mobile terminal continuously reproduce the sensory effect media by the user selection. Although the function of reproducing the sensory effect media of the mobile terminal is smaller than that of the sensory effect media consuming apparatus in home, the sensory effect media consuming apparatus of the mobile terminal searches sensory effect devices of the mobile terminal and reproduces the sensory effects in the mobile terminal using the searched sensory effect devices.

The method of the present invention described above can be realized as a program and stored in a computer-readable recording medium such as CD-ROM, RAM, ROM, floppy disks, hard disks, magneto-optical disks and the like. Since the process can be easily implemented by those skilled in the art to which the present invention pertains, further description will not be provided herein.

While the present invention has been described with respect to the specific embodiments, it will be apparent to those skilled in the art that various changes and modifications may be made without departing from the spirit and scope of the invention as defined in the following claims.

### INDUSTRIAL USABILITY

The method and apparatus for generating and consuming sensory effect media according to the present invention are used to generate and consume the sensory effect media.

What is claimed is:

1. A method for generating sensory effect media, comprising:
receiving sensory effect information about sensory effects that are applied to media; and
generating sensory effect metadata including the received sensory effect information.

2. The method of claim 1, further comprising:
transmitting the sensory effect metadata to a user terminal.

3. The method of claim 1, further comprising:
generating sensory effect media by packaging the generated sensory effect metadata and the media; and
transmitting the sensory effect media to the user terminal.

4. The method of claim 1, wherein the sensory effect information includes special effect information for reproducing sensory effects and control information for controlling devices that perform the sensory effects.

5. The method of claim 4, wherein the control information includes synchronization information for synchronizing the media with the sensory effects.

6. An apparatus for generating sensory effect media, comprising:
an input unit for receiving sensory effect information about sensory effects that are applied to media; and
a sensory effect metadata generator for generating sensory effect metadata including the received sensory effect information.

7. The apparatus of claim 6, further comprising:
a transmitter for transmitting the sensory effect metadata to a user terminal.

8. The apparatus of claim 6, further comprising:
a sensory effect generator for generating sensory effect media by packaging the generated sensory effect metadata and the media,
wherein the transmitter transmits the sensory effect media to the user terminal.

9. The apparatus of claim 6, wherein the sensory effect information includes special effect information for reproducing the sensory effects and control information for controlling devices that perform the sensory effects.

10. The apparatus of claim 9, wherein the control information includes synchronization information for synchronizing the media and the sensory effects.

11. A method for consuming sensory effect media, comprising:
receiving sensory effect metadata including sensory effect information about sensory effects that are applied to media; and
searching for devices that performs the sensory effects and controlling the devices according to the sensory effect information.

12. The method of claim 11, wherein in said receiving sensory effect metadata,
the media is further received.

13. The method of claim 12, wherein the media is packaged with the sensory effect metadata.

14. The method of claim 11, wherein the sensory effect information includes special effect information for reproducing the sensory effects and control information for controlling devices that perform the sensory effects.

15. The method of claim 14, wherein the control information includes synchronization information for synchronizing the media and the sensory effect.

16. An apparatus for consuming sensory effect media, comprising:
an input unit for receiving sensory effect metadata having sensory effect information about sensory effects that are applied to media; and
a controller for searching for devices that performs the sensory effects and controlling the devices according to the sensory effect information.

17. The apparatus of claim 16, wherein the input unit further receive the media.

18. The apparatus of claim 17, wherein the media is packaged with the sensory effect metadata.

19. The apparatus of claim 16, wherein the sensory effect information includes special information for reproducing the sensory effects and control information for controlling devices that perform the sensory effects.

20. The apparatus of claim 19, wherein the control information include synchronization information for synchronizing the media and the sensory effect.
